(19) United States
(12) Patent Application Publication
(10) Pub. No.: US 2024/0096060 A1
(43) Pub. Date: Mar. 21, 2024

(54) DEVICE AND COMPUTER IMPLEMENTED METHOD FOR DETERMINING A CLASS OF AN ELEMENT OF AN IMAGE IN PARTICULAR FOR OPERATING A TECHNICAL SYSTEM

(71) Applicant: Robert Bosch GmbH, Stuttgart (DE)

(72) Inventors: Maksym Yatsura, Dornstetten (DE); Jan Hendrik Metzen, Boeblingen (DE); Matthias Hein, Tübingen (DE)

(21) Appl. No.: 18/463,460

(22) Filed: Sep. 8, 2023

(30) Foreign Application Priority Data
Sep. 12, 2022 (DE) 10 2022 209 501.4

(51) Int. Cl. G06V 10/764; G06T 1/00; G06V 10/22; G06V 20/70

(52) U.S. Cl. CPC G06V 10/764; G06T 1/0014; G06V 10/225; G06V 20/70

(57) ABSTRACT

A device and computer-implemented method for determining a class of an element of an image in particular for operating a technical system. The method includes providing a first set of elements representing the image, providing a set of masks, determining a set of predictions for the class, and determining the class of the element depending on the set of predictions, wherein determining the set of predictions comprises determining a second set of elements representing the image depending on the first set of elements and a mask of the set of masks, wherein the mask indicates unmasked elements of the image and/or masked elements of the image, and determining a prediction for the set of predictions depending on the second set of elements.

### CROSS REFERENCE

The present application claims the benefit under 35 U.S.C. § 119 of German Patent Application No. DE 10 2022 209 501.4 filed on Sep. 12, 2022, which is expressly incorporated herein by reference in its entirety.

### FIELD

The present invention concerns a device and a computer implemented method for determining a class of an element of an image in particular for operating a technical system.

### BACKGROUND INFORMATION

Physically realizable adversarial attacks upon image classification are a threat in particular for a reliable operation of the technical system.

An adversarial patch is an example of such an attack. Tom Brown, Dandelion Mane, Aurko Roy, Martin Abadi, and Justin Gilmer; “Adversarial patch;” in Advances Neural Information Processing System (NeurIPS), 2017; URL https://arxiv.org/pdf/1712.09665.pdf; arXiv: 1712.09665, and Danny Karmon, Daniel Zoran, and Yoav Goldberg; “LaVAN: Localized and visible adversarial noise;” in International Conference on Machine Learning (ICML), pages 2507-2515, 2018, URL https://proceedings.mlr.press/v80/karmon18a.html describe aspects of such a patch.

Mark Lee and J. Zico Kolter; “On physical adversarial patches for object detection;” International Conference on Machine Learning (Workshop), 2019, URL http://arxiv.org/abs/1906. 11897, describes aspects of such an attack.

Alexander Levine and Soheil Feizi; “(De)Randomized Smoothing for Certifiable Defense against Patch Attacks;” in Advances in Neural Information Processing Systems (NeurIPS), volume 33, 354 2020, describes a defense against such attacks that is based on masking different parts of an input image.

### SUMMARY

A method and a device for image classification according to the present invention include a defense for an attack with an adversarial patch, which enables safety-critical applications with improved robustness against adversarial patch attacks.

According to an example embodiment of the present invention, the computer-implemented method for determining a class of an element of an image in particular for operating a technical system, includes providing a first set of elements representing the image, providing a set of masks, determining a set of predictions for the class, and determining the class of the element depending on the set of predictions, wherein determining the set of predictions comprises determining a second set of elements representing the image depending on the first set of elements and a mask of the set of masks, wherein the mask indicates unmasked elements of the image and/or masked elements of the image, and determining a prediction for the set of predictions depending on the second set of elements. The element is, e.g., a pixel of the image. The second set of elements represents unmasked and masked elements. The prediction is determined depending on the unmasked elements and a reconstruction of the masked elements that is based on the unmasked elements. The class for the element is provided, e.g., for a semantic segmentation of the image.

According to an example embodiment of the present invention, determining the class may comprise determining the class depending on a prediction in the set of predictions that is more frequent than at least one other prediction in the set of predictions, preferably depending on the most frequent prediction in the set of predictions. This provides a defense against patch attacks.

According to an example embodiment of the present invention, the method may comprise determining the set of predictions for different elements of the image. This provides a semantic segmentation of the image that is robust against patch attacks.

According to an example embodiment of the present invention, the method may comprise determining an indication whether the predictions in the set of predictions predict the same class or not. This provides a certified defense against patch attacks for the semantic segmentation.

According to an example embodiment of the present invention, the method preferably comprise determining a map that comprises a respective indication for different elements of the image. This map provides a certification for a semantic segmentation result.

According to an example embodiment of the present invention, preferably, the method comprises outputting an alarm and/or controlling a technical system in response to determining that at least one prediction is different from at least one prediction in the set of predictions. The alarm informs about a detected attack.

According to an example embodiment of the present invention, the method may comprise determining the mask to indicate a group of masked elements representing a region of the image, wherein the region matches a predetermined patch in size and shape or that is larger than a patch that has predetermined dimensions in at least one of the dimensions, or determining the mask to indicate several groups of masked elements representing several different regions of the image, wherein the different regions individually match a predetermined patch in size and shape or that are larger than a patch that has predetermined dimensions in at least one of the dimensions. This mask is capable of covering the entire patch, so it is possible to determine at least one prediction without any element of the image that comprises a part of the patch.

According to an example embodiment of the present invention, the method may comprise determining different masks of the set of masks to indicate different groups of masked elements representing different regions of the image. This distribution of the different masks in different regions makes is possible to determine at least one prediction without any element of the image that comprises a part of the patch.

The present invention also provides a device for determining a class of an element of an image. According to an example embodiment of the present invention, the device comprises at least one processor and at least one memory, wherein the at least one processor and the at least one memory are configured for executing the method.

The present invention also provides a technical system, in particular an at least partially autonomous computer-controlled machine, preferably a robot, a vehicle, a domestic appliance, a power tool, a manufacturing machine, a personal assistant or an access control system, the technical system comprising the device.

The present invention also provides a computer program which comprises computer-readable instructions that when executed by a computer cause the computer to execute the method according to the present invention.

Further embodiments of the present invention are derived from the disclosure herein.

### BRIEF DESCRIPTION OF THE DRAWINGS

FIG. 1 shows a device for semantic segmentation of an image, according to an example embodiment of the present invention.

FIG. 2 shows a first example of a semantic segmentation procedure for the image, according to the present invention.

FIG. 3 shows a second example of a semantic segmentation procedure for the image, according to the present invention.

FIG. 4 shows steps in a method for semantic segmentation of the image, according to an example embodiment of the present invention.

FIG. 5 shows a technical system comprising the device, according to an example embodiment of the present invention.

FIG. 6 depicts schematically a method of operating the technical system, according to an example embodiment of the present invention.

### DETAILED DESCRIPTION OF EXAMPLE EMBODIMENTS

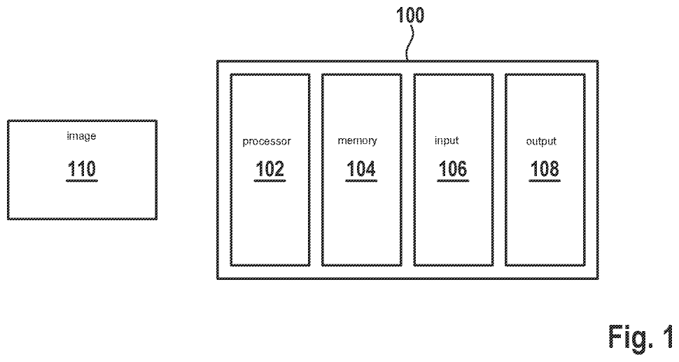

FIG. 1 depicts a device 100 for semantic segmentation.

The device 100 comprises at least one processor 102 and at least one memory 104. The device 100 may comprise an input 106. The device 100 may comprise an output 108. The input 106 may comprise a communication interface.

The device 100 is configured for determining a class s_{i,j} of an element x_{i,j} of an image 110.

The device 100 is for example configured to store the image 110. The device 100 is for example configured to receive the image 110 at the input 106.

The at least one processor 102 and the at least one memory 104 are configured for executing a method for determining the class s_{i,j} of the element x_{i,j} of the image 110.

The device 100 is for example configured to output an alarm at the output 108, in particular depending on the class of at least one of the elements x_{i,j} of the image 110.

The at least one processor 102 is for example configured to execute a computer program comprising computer-readable instructions that when executed by a computer cause the computer to execute the method. The at least one memory 104 is for example configured to store the computer program.

The computer-implemented method provides a certified defense against adversarial patch attacks on semantic segmentation models. In such attack, a patch is placed at a region in the image 110, in order to mislead the mode to an erroneous semantic segmentation.

The method aims at deleting an adversarial patch regardless of its location with a set of K masks {m^{k}}₁^{K} that results in masked images that maintain a structure of the image 110 and allow restoring masked parts in a restored image from the unmasked parts. An arbitrary downstream semantic segmentation model is applied to this restored image for determining the classes s_{i,j} of the elements x_{i,j}.

The image 110 is referred to as image x∈X of a set of images. In the example, the image x comprises J columns and I rows. The image x in the example comprises a first set of elements {x_{i,j}}_{i=1, . . . I;j=1, . . . J}∈[0,1]^{H×W×C} with height H=I and width W=J and a number or channels C, wherein 1 indicates the presence and 0 indicates the absence of a visible element comprising the respective channel at a location given by the index i,j of the element.

A ground truth segmentation map for the image 110 is denoted as {s_{i,j}}_{i=1, . . . I;j=1, . . . J}∈Y^{H×W} wherein the class s_{i,j}∈S of a finite set of segmentation maps S that is assigned to an element is addressed by the index i,j of the element. The class s_{i,j} in the example represents a given label of a finite set of labels Y. The label is for example from a domain, e.g., for describing a traffic infrastructure. A label may be “vehicle”, “traffic sign” “house”, “church”, “tree”.

A first model f: X→S is configured for semantic segmentation.

An accuracy of the first model f is evaluable, e.g., by a map M(f, x, s)∈{0,1}^{H×W} such that M(f, x, s)_{i,j}:=[f (x_{i,j}=s_{i,j}], where [P]=1 if P=TRUE and Zero otherwise. Considering a quality metric Q(f, x, s) an accuracy Acc of the semantic segmentation is evaluable, e.g., by

$$A c c ( f , x , s ) := \frac{1}{H \cdot W} {\sum }_{i = 1}^{H} {\sum }_{j = 1}^{W} {M ( f , x , s )}_{i , j}$$

Assuming that an attacker can modify an arbitrary region of the image x that has a rectangular shape and a size of H′×W′, this region is referred to as patch. In the example, the patch of rectangular shape is described. Patches of other shapes are treated alike. A mask, in particular a binary mask l∈[0,1]^{H×W} defines a patch location in the image 110, e.g., wherein 1 indicates the presence of an element of the patch and 0 indicates the absence of any element of the patch. A content of the patch, i.e., the modification itself, is referred to as p∈[0,1]^{H×W×C} wherein. Assuming that an attacker may place the patch at any suitable location, P:=[0,1]_{H×W×C}×L denotes the possible patch configurations (p, l) that define the patch.

In the example, a mask m^{k} of the set of masks {m^{k}}₁^{K} indicate elements of the first set of elements {x_{i,j}}_{i=1, . . . I;j=1, . . . J}. that are masked and elements of the first set of elements that are unmasked. The mask m^{k} may be a map {m_{i,j}}^{k}_{i=1, . . . I;j=1, . . . J}∈{*,1}^{H×W} of the same dimension as the image x. In the example, the map {m_{i,j}}^{k}_{i=1, . . . I;j=1, . . . J} is a map indicating a masked element with a special symbol, e.g. *, which does not correspond to any value and has the property that ∀z∈ [symbol] : z×*=*. Another symbol or a binary map may be used to indicate that an element is a masked element. The mask m^{k} hides a patch location I, if ∀i, j: (l⊙m^{k})_{i,j}≠1.

An operator A(x,p,l)=(1−l)⊙x+⊙p applies the H′×W′ subregion of p that is defined by the binary mask l to the first set of elements {x_{i,j}}^{k}_{i=1, . . . I;j=1, . . . J}, i.e., the image x, while keeping the rest of the first set of elements {x_{i,j}}^{k}_{i=1, . . . I;j=1, . . . J} unchanged.

The goal of an attacker is to find

$$( {p}^{*} , {l}^{*} ) = arg {min}_{( p , l ) ∈ P} Q ( f , A ( x , p , l ) , s )$$

A certified recovery from an attack is available, in case the following statement is true:

∀(p,l)∈P:f(A(x,p,l))_{i,j}=f(x)_{i,j}

A certified detection of an attack is available with a verification function v(x)∈{0,1}^{H×W}, wherein v(x)_{i,j}=1 means that no adversarial patch is present in the element x_{i,j} or the semantic segmentation of the element x_{i,j} is unaffected by the patch. The certified detection of the attack is available in case the following statement is true:

∀(p,l)∈P:v(A(x,p,l))_{i,j}=1→f(A(x,p,l))=f(x)_{i,j}

The set of masks {m^{k}}₁^{K} that is used for the certified detection differs in the example from the set of masks {m^{k}}₁^{K} that is used for certified recovery.

An exemplary set of masks {m^{k}}₁^{K} for the certified recovery comprises K≥2T+1 masks:

M(K,L,T)={m^{k}}₁^{K}

such that for any patch location l∈L there exists at least K−T masks that hide the patch completely, that is ∀p: A(x, p, l)⊙m^{k}=x⊙m^{k}. It means that no more than T maskings contain pixels of the patch, i.e., are affected by it. In this context masking refers to an element-wise product x⊙m^{k} in which a subset of pixels is hidden by the symbol, e.g. *, and the rest is unchanged.

According to one example, such a set of masks is determined for a patch size H′×W′. The image x is divided into a set of blocks B={b_{i,j}} of size H′×W′

wherein 1≤i≤H^{B}=[H/H′] and 1≤j≤W^{B}=[W/W′]. Considering q: B {1, . . . , K} such that if q(b_{i,j})=k then m^{k} is composed such that b_{i,j} is unmasked, i.e., not masked. This means, the mask m^{k} is defined by a B^{k}⊂B s.t. for b∈B^{k}q(b)=k.

According to one example, for T=2, constructing the set of masks M(K, L, 2) comprises determining if j=k mod K and if so, for 1≤i≤W^{B} assign q(b_{i,j})=k. This means, every k-th column is assigned to the mask m^{k}. Any patch can intersect at most two adjacens columns, since it has the same width as a column. Therefore, any patch can affect at most two maskings.

According to one example, for T=3 the blocks in each row may be assigned to the masks as follows: For a first row q(b_{1,1})=1; q(b_{1,2})=q(b_{1,3})=2; q(b_{1,2})=q(b_{1,5})=3 and so on until reaching the end of the first row. Assuming the first row ends with a value of k, the blocks for a second row are assigned to the masks as follows q(b_{2,1})=q(b_{2,2})=k+1; q(b_{2,3})=q(b_{2,4})=k+2 and so on until reaching the end of the second row. Assuming the second row ends with a value of n, the blocks for a third row are assigned to the masks as follows q(b_{3,1})=n+1; q(b_{3,2})=q(b_{3,3})=n+2 and so on until reaching the end of the third row. Once the number of K is reached, the assigning is continued with 1. Due to the block size, the patch cannot intersect more than four blocks at once. This parity-alternating block sequence ensures that in any such intersection of four blocks either the top ones or the bottom ones will belong to the same masking, so at most T=3 different maskings can be affected.

For T≥4 any assignment of masks may be used due to the aforementioned block size. In one example, a uniform distribution of the unmasked blocks may be used. In one example each masking keeps approximately 1=K of the elements of the image x visible and the unmasked regions are densely spread in the image x. Densly spread means that for any masked pixel there exists an unmasked region located at a distance to this element, wherein the distance depends on K and T.

An exemplary set of masks {m^{k}}₁^{K} for the the certified detection comprises for a patch of size H′×W′K=W−W′+1 masks:

M(K,L)={m^{k}}₁^{K}

such that for any patch location l∈L there exists at least one mask that hides the patch completely. Starting, e.g., at left top corner of the image x in a horizontal position k, the mask m^{k} for example hides a column of width W′.

To obtain the guarantee for the same location L with a smaller K, the mask m k a may comprise a set of strided columns of width W″≥W′ and stride W″−W′+1.

The scheme of the masks is described above for columns. The scheme may be used for masking of rows in the same way as well.

A set of block masks of size H′×W′ may be used as well. Then the number of masks grows quadratically with the image size or resolution.

In order to reconstruct the masked elements, a second set of elements is determined with a second model g. The second set of elements corresponds to the reconstructed image. An exemplary second model is a demasking model, g (x⊙m^{k})∈[0,1]^{H×W×C}, wherein ⊙ is the element-wise product. This means in an input for the second model g, the masked elements are set to the symbol, e.g. *, and the model is configured to process this symbol.

The first (model f is configured to determine a segmentation set S(M,x,g,f):={s^{k}=f(g(x⊙m^{k}))|m^{k}∈M}

The second set of elements is determined in the example, for a plurality of masked images that result from masking the image 110 with different masks m^{k} from the set of masks {m^{k}}₁^{K}.

A prediction for the class s_{i,j} is determined depending on the first model f. An input to the first model f is the second set of elements. An exemplary first model is f(g(x⊙m^{k})). In the example, a set of K predictions {f(g(x⊙m^{k}))}₁^{K} for the class s_{i,j} is determined.

The class s_{i,j} of the element x_{i,j} is determined depending on the set of predictions {f(g(x⊙m^{k}))}₁^{K}.

In one example, a function h: X→S is defined that assigns a class s_{i,j}∈S(M,x,g,f) to an element x_{i,j} via majority voting over the classes s_{i,j} assigned by the different predictions to the same element x_{i,j}. A class for the element x_{i,j} that is predicted by the largest number of predictions is for example assigned to this element x_{i,j}. In case of a tie, a class s^{k} with a smallest index k is assigned in one example. This means, the class is set to a prediction in the set of predictions that is more frequent than at least one other prediction in the set of predictions, preferably to the most frequent prediction in the set of predictions. This means, the class ist determined depending on the most frequent prediction in the set of predictions.

The method is described for a mask M k that comprises at least one region with two dimensions. In the example, the at least one region is rectangular. The region may have another shape. In the example, the at least one region corresponds to elements of a group of elements that are masked. The at least one region may correspond to at least one column of the image 110. The at least one region may correspond to at least one row of the image 110. The at least one region may correspond to any other group of elements.

A structure of functions f, g and h may have an arbitrary internal form given that the specified outputs are given for the specified inputs.

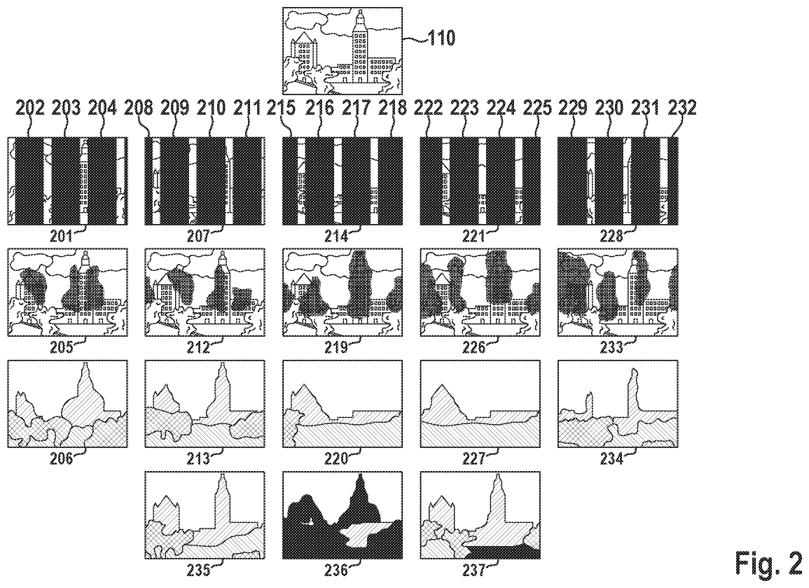

FIG. 2 depicts a first example of a semantic segmentation procedure for the image 110.

In the first example, a first masked image 201 is determined with a first mask m¹.

The first mask m¹ indicates a first group of masked elements 202, a second group of masked elements 203 and a third group of masked elements 204 representing three different regions of the image.

The first masked image 201 is mapped with the second model g to a first reconstructed image 205. The first reconstructed image 205 is mapped with the first model f to a first prediction 206 for a semantic segmentation of the image 110.

In the first example, a second masked image 207 is determined with a second mask m².

The second mask m² indicates a first group of masked elements 208, a second group of masked elements 209 and a third group of masked elements 210 and a fourth group of masked elements 211 representing four different regions of the image.

The second masked image 207 is mapped with the second model g to a second reconstructed image 212. The second reconstructed image 212 is mapped with the first model f to a second prediction 213 for a semantic segmentation of the image 110.

In the first example, a third masked image 214 is determined with a third mask m³.

The third mask m³ indicates a first group of masked elements 215, a second group of masked elements 216 and a third group of masked elements 217 and a fourth group of masked elements 218 representing four different regions of the image.

The third masked image 214 is mapped with the second model g to a third reconstructed image 219. The third reconstructed image 219 is mapped with the first model f to a third prediction 220 for a semantic segmentation of the image 110.

In the first example, a fourth masked image 221 is determined with a fourth mask m⁴.

The fourth mask m⁴ indicates a first group of masked elements 222, a second group of masked elements 223 and a third group of masked elements 224 and a fourth group of masked elements 225 representing four different regions of the image.

The fourth masked image 221 is mapped with the second model g to a fourth reconstructed image 226. The fourth reconstructed image 226 is mapped with the first model f to a fourth prediction 227 for a semantic segmentation of the image 110.

In the first example, a fifth masked image 228 is determined with a fifth mask m⁵.

The fifth mask m⁵ indicates a first group of masked elements 229, a second group of masked elements 230 and a third group of masked elements 231 and a fourth group of masked elements 232 representing four different regions of the image.

The fifth masked image 228 is mapped with the second model g to a fifth reconstructed image 233. The fifth reconstructed image 234 is mapped with the first model f to a fifth prediction 234 for a semantic segmentation of the image 110.

In the first example, the different regions are distributed within an image and across the different images according to a given set of masks {m^{k}}₁^{K}.

A prediction 235 for the semantic segmentation is determined depending on the the first prediction 206, the second prediction 213, the third prediction 220, the fourth prediction 227 and the fifth prediction 234, e.g., by majority voting over the predictions for the individual elements in the predictions.

A map 236 that comprises for the elements of the image 110 an indication whether the predictions in the set of predictions predict the same class s_{i,j} or not, is determined depending on the the first prediction 206, the second prediction 213, the third prediction 220, the fourth prediction 227 and the fifth prediction 234. The map 236 comprises a respective indication for different elements of the image 110.

In a training, the first model f and/or the second model g and/or the function h are trained, e.g., depending on a ground truth segmentation map 237 to predict the map 236 and/or the prediction 235 for the image 110.

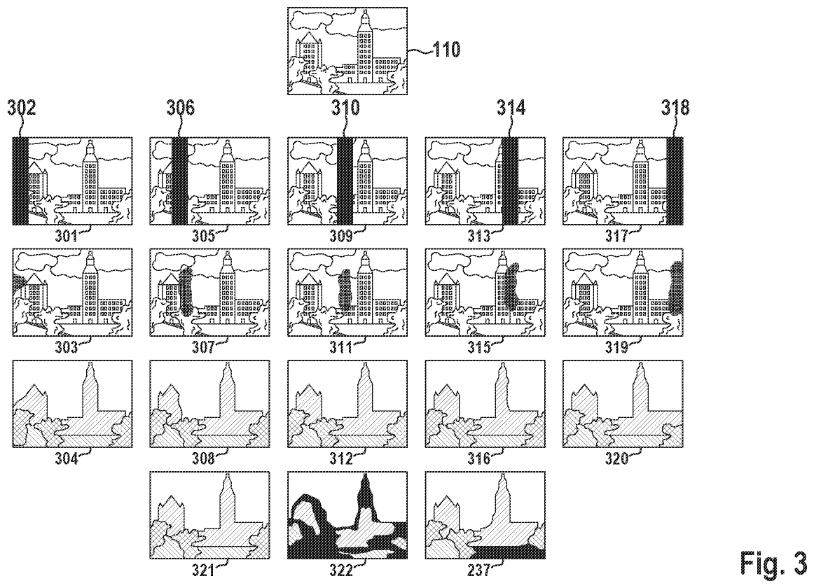

FIG. 3 depicts a second example of a semantic segmentation procedure for the image 110.

In the second example, a first masked image 301 is determined with a first mask m¹.

The first mask m¹ indicates a group of masked elements 302 representing a region of the image. The region individually matches a predetermined patch in size and shape or is larger than a patch that has predetermined dimensions in at least one of the dimension.

The first masked image 301 is mapped with the second model g to a first reconstructed image 303. The first reconstructed image 303 is mapped with the first model f to a first prediction 304 for a semantic segmentation of the image 110.

In the second example, a second masked image 305 is determined with a second mask m².

The second mask m² indicates a group of masked elements 306 representing a region of the image.

The second masked image 305 is mapped with the second model g to a second reconstructed image 307. The second reconstructed image 307 is mapped with the first model f to a second prediction 308 for a semantic segmentation of the image 110.

In the second example, a third masked image 309 is determined with a third mask m³.

The third mask m³ indicates a group of masked elements 310 representing a region of the image.

The third masked image 309 is mapped with the second model g to a third reconstructed image 311. The third reconstructed image 311 is mapped with the first model f to a third prediction 312 for a semantic segmentation of the image 110.

In the second example, a fourth masked image 313 is determined with a fourth mask m⁴.

The fourth mask m⁴ indicates a group of masked elements 314 representing a region of the image.

The fourth masked image 313 is mapped with the second model g to a fourth reconstructed image 315. The fourth reconstructed image 315 is mapped with the first model f to a fourth prediction 316 for a semantic segmentation of the image 110.

In the second example, a fifth masked image 317 is determined with a fifth mask m⁵.

The fifth mask m⁵ indicates a group of masked elements 318 representing a region of the image.

The fifth masked image 317 is mapped with the second model g to a fifth reconstructed image 319. The fifth reconstructed image 319 is mapped with the first model f to a fifth prediction 320 for a semantic segmentation of the image 110.

The regions in the second example individually match a predetermined patch in size and shape or are individually larger than a patch that has predetermined dimensions in at least one of the dimension. In the second example, the regions of different images are distributed according to a given set of masks {m^{k}}₁^{K}.

A prediction 321 for the semantic segmentation is determined depending on the the first prediction 304, the second prediction 308, the third prediction 312, the fourth prediction 316 and the fifth prediction 320, e.g., by majority voting over the predictions for the individual elements in the predictions.

A map 322 that comprises for the elements of the image 110 an indication whether the predictions in the set of predictions predict the same class s_{i,j} or not, is determined depending on the the first prediction 304, the second prediction 308, the third prediction 312, the fourth prediction 316 and the fifth prediction 320. The map 322 comprises a respective indication for different elements of the image 110.

In a training, the first model f and/or the second model g and/or the function h are trained, e.g., depending on the ground truth segmentation map 237 to predict the map 321 and/or the prediction 322 for the image 110.

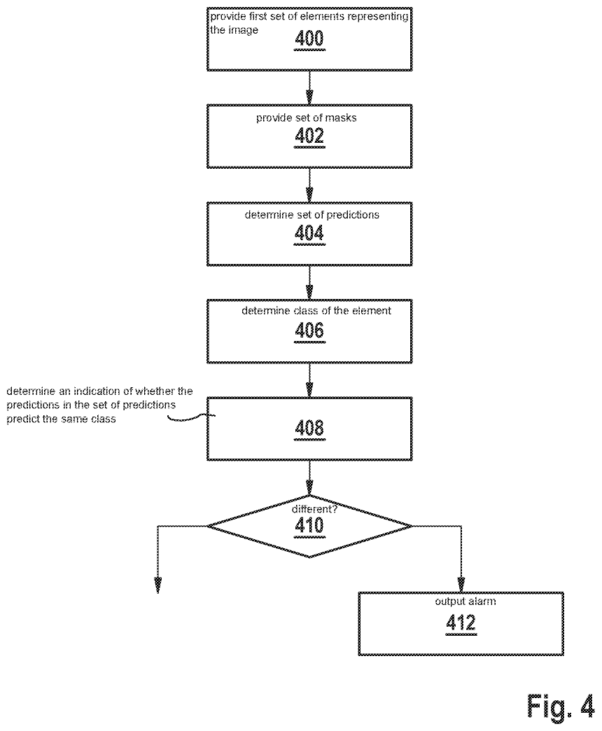

FIG. 4 depicts steps in a computer-implemented method for determining a class s_{i,j} of an element x_{i,j} of the image 110.

The method comprises a step 400.

In step 400 a first set of elements x representing the image 110 is provided

The method comprises a step 402.

In step 402, the set of masks {m^{k}}₁^{K} is provided.

The method comprises a step 404.

In step 404, the set of predictions {f(g(x⊙m^{k}))}₁^{K} is determined.

The mask m^{k} in the set of masks {m^{k}}₁^{K} indicates unmasked elements of the image and/or masked elements of the image. Different masks of the set of masks {m^{k}}₁^{K} to indicate different groups of masked elements representing different regions of the image.

The method comprises a step 406.

In step 406, the class s_{i,j} of the element x_{i,j} is determined depending on the set of predictions.

The method comprises a step 408.

In step 408, an indication whether the predictions in the set of predictions predict the same class s_{i,j} or not is determined.

In the example, the map 236 or 322 that comprises a respective indication for different elements of the image is determined.

The method comprises a step 410.

In step 410 it is determined whether at least one prediction is different from at least one prediction in the set of predictions. In case at least one prediction is different from at least one prediction in the set of predictions, a step 412 is executed. Otherwise the method may end or be repeated for another image.

In step 412, an alarm is output.

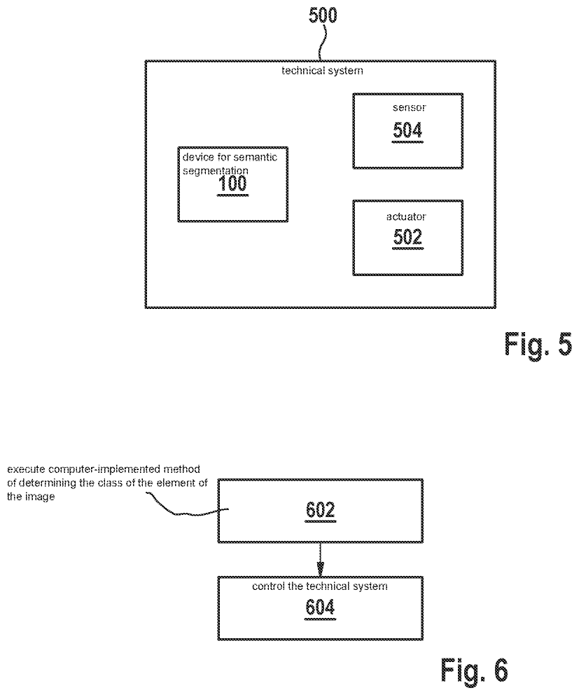

FIG. 5 depicts schematically a technical system 500, in particular a physical system. the technical system 500 comprises the device 100.

The technical system 500 may be an at least partially autonomous computer-controlled machine, in particular a robot like a vehicle, a domestic appliance, a power tool, a manufacturing machine, a personal assistant or an access control system.

The technical system 500 comprises an actuator 502. The actuator 502 is configured to control the technical system 500. The technical system comprises for example an engine and/or a steerable and/or movable part, e.g., a wheel or an arm. The actuator 502 is for example configured for moving the technical system 500 or the part. The actuator 502 is for example configured for operating the engine and/or steering and/or braking the technical system 500 or the part.

In the example, the actuator 502 is configured to operate the technical system 500 depending on the semantic segmentation of the image 110.

The technical system 500 may comprise a sensor 504. The sensor 504 is configured to capture the image 110. The sensor 504 comprises for example a camera, a LiDAR sensor, a radar sensor, a motion sensor, an ultrasonic sensor, an infrared sensor. The technical system 500 may comprise to receive the image 110, e.g., from its environment, e.g., an infrastructure, in particular at the input 106.

FIG. 6 depicts schematically a method of operating the technical system 500.

The method comprises a step 602.

In the step 602 the computer-implemented method for determining the class s_{i,j} of the element x_{i,j} of the image 110 is executed. The image 110 is for example captured by the sensor 504.

The method comprises a step 604.

In the step 604, the technical system 500 is controlled.

In one example, the technical system 500 is operated independent off the semantic segmentation of the image 110 in response to determining 410 that at least one prediction is different from at least one prediction in the set of predictions. Otherwise, the technical system 500 may be operated depending on the semantic segmentation of the image 110.

What is claimed is:

1. A computer-implemented method for determining a class of an element of an image for operating a technical system, the method comprising the following steps:
providing a first set of elements representing the image;
providing a set of masks;
determining a set of predictions for the class; and
determining the class of the element depending on the set of predictions, wherein the determining of the set of predictions includes determining a second set of elements representing the image depending on the first set of elements and a mask of the set of masks, wherein the mask indicates unmasked elements of the image and/or masked elements of the image, and determining each prediction for the set of predictions depending on the second set of elements.

2. The method according to claim 1, wherein the determining of the class includes determining the class depending on a prediction in the set of predictions that is more frequent than at least one other prediction in the set of predictions.

3. The method according to claim 1, wherein the determining of the class includes determining the class depending on a prediction in the set of predictions that is a most frequent prediction in the set of predictions.

4. The method according to claim 1, further comprising determining the set of predictions for different elements of the image.

5. The method according to claim 1, further comprising determining an indication whether the predictions in the set of predictions predict the same class or not.

6. The method according to claim 5, further comprising determining a map that includes a respective indication for different elements of the image.

7. The method according to claim 1, further comprising outputting an alarm and/or controlling a technical system in response to determining that at least one prediction is different from at least one prediction in the set of predictions.

8. The method according to claim 1, further comprising: i) determining the mask to indicate a group of masked elements representing a region of the image, wherein the region matches a predetermined patch in size and shape or that is larger than a patch that has predetermined dimensions in at least one of the dimensions, or ii) determining the mask to indicate several groups of masked elements representing several different regions of the image, wherein the different regions individually match a predetermined patch in size and shape or that are larger than a patch that has predetermined dimensions in at least one of the dimensions.

9. The method according to claim 1, further comprising determining different masks of the set of masks to indicate different groups of masked elements representing different regions of the image.

10. A device configured to determine a class of an element of an image, the devic comprising:
at least one processor; and
at least one memory;
wherein the at least one processor and the at least one memory are configured to:
provide a first set of elements representing the image,
provide a set of masks,
determine a set of predictions for the class, and
determine the class of the element depending on the set of predictions, wherein the determining of the set of predictions includes determining a second set of elements representing the image depending on the first set of elements and a mask of the set of masks, wherein the mask indicates unmasked elements of the image and/or masked elements of the image, and determining each prediction for the set of predictions depending on the second set of elements.

11. The device according to claim 10, wherein the device is a technical system including an at least partially autonomous computer-controlled machine, the at least partially autonomous computer-controlled machine including a robot, or a vehicle, or a domestic appliance, or a power tool, or a manufacturing machine, or a personal assistant, or an access control system.
